(19) United States
(12) Patent Application Publication
(10) Pub. No.: US 2006/0228273 A1
(43) Pub. Date: Oct. 12, 2006

(54) Exhaust element retaining assembly

(75) Inventor: Ronald Paul Maloney, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/099,611

(22) Filed: Apr. 6, 2005

(51) Int. Cl. B01D 50/00

(52) U.S. Cl. 422/177

(57) ABSTRACT

An exhaust element assembly includes an exhaust element and a retaining mat surrounding at least a portion of the exhaust element. The assembly may also include a housing having a plurality of recessed areas on an inner surface of the housing, the housing being configured to engage the retaining mat such that at least a portion of the retaining mat extends at least partially into one or more of the plurality of recessed areas under influence of force exerted on the retaining mat by the housing.

### TECHNICAL FIELD

The present disclosure generally relates to an assembly for retaining an exhaust element, and more particularly, to an assembly using recessed features to retain the exhaust element.

### BACKGROUND

Various types of work machines may include one or more engines that emit exhaust gas, which may include air pollutants. Various types of exhaust elements may be used to reduce the amount of air pollutants contained in the exhaust gas. Thus, the use of these exhaust elements may cause the gas exiting the exhaust element to be cleaner than the gas entering it.

One of the exhaust elements may include a catalytic converter, a particulate trap or any other such device that may be configured to reduce some of the harmful air pollutants in the exhaust gas. The exhaust element may include a catalyst that helps reduce the air pollutants in the gas. For example, the exhaust element may include a ceramic structure coated with a metal catalyst, usually platinum, rhodium and/or palladium.

Various techniques have been used to mount exhaust elements and place them in housings. Some of these include using some form of mechanical coupling to hold the exhaust element. For example, some assemblies use a retaining ring welded to a housing surrounding the exhaust element. This ring, in conjunction with a flange on the housing, may help retain the element in the housing. Yet another assembly may use a clamp ring welded on the inner surface of the housing surrounding the element to hold the element. Some assemblies may also include dimples or abutments on the housing surrounding the exhaust element to help retain the element.

An exhaust element mounted in an exhaust system may be subjected to various forces that may tend to loosen or dislodge the element from its mounted location. For example, the element may be subject to shocks, exhaust gas loads, and vibrations during normal operation of the work machine. The forces from these shocks and vibrations may cause the element to move from its intended position. Moreover, if an exhaust element is mounted in the vertical position, the problem may worsen due to the gravitational forces operating on the element, which may further cause the element to slip from its desired position. Thus, there is a need for mounting configurations that can hold an exhaust element in a manner such that the exhaust element retains its position during the operation of the work machine.

Various mounting arrangements have been proposed to retain exhaust elements in engine exhaust treatment systems. For example, U.S. Pat. No. 5,116,581 (“the '581 patent”) to Cyron et al., which issued on May 26, 1992, discusses a mounting assembly to retain an exhaust gas catalyst. The assembly of the '581 patent includes a catalyst body with beads encircling at least a portion of the body. These beads mate with formations formed on a tubular jacket that surrounds the catalyst. Thus, the beads help hold the catalyst body to the tubular jacket in a lock and key configuration.

Although the mounting assembly of the '581 patent may help hold the catalyst body to the surrounding jacket with the lock and key configuration, the assembly may nevertheless have several shortcomings. This assembly may increase the manufacturing costs of the catalysts in view of the beads that must be formed on the catalyst body. Further, in order for the assembly to function properly, the formations on the jacket and the beads on the catalyst body must fit together exactly. Thus, any error in manufacturing may prevent the assembly from working as desired. Moreover, regular wear and tear may subject the beads to pressure that may cause them to break.

The present disclosure is directed to overcoming one or more of the problems set forth above.

### SUMMARY OF THE INVENTION

One aspect of the present disclosure is an exhaust element assembly. This assembly includes an exhaust element and a retaining mat surrounding at least a portion of the exhaust element. The assembly may also include a housing having a plurality of recessed areas on an inner surface of the housing, the housing being configured to engage the retaining mat such that at least a portion of the retaining mat extends at least partially into one or more of the plurality of recessed areas under influence of force exerted on the retaining mat by the housing.

Another aspect of the present disclosure may include a method of retaining an exhaust element. This method may include surrounding at least a portion of the exhaust element with a retaining mat. The method may also include engaging the retaining mat with a housing that includes a plurality of recessed area on an inner surface of the housing. The method may also include exerting a force on the retaining mat by the housing, so that at least a portion of the retaining mat extends at least partially into one or more of the plurality of recessed areas.

Yet another aspect of the present disclosure may include a machine. The machine may include a frame and an engine, which generates an exhaust stream, operably connected to the frame. The machine may also include an exhaust element assembly. The assembly may include an exhaust element.

The assembly may also include a retaining mat surrounding at least a portion of the exhaust element. The assembly may further include a housing having a plurality of recessed areas on an inner surface of the housing, the housing being configured to engage the retaining mat such that at least a portion of the retaining mat extends at least partially into one or more of the plurality of recessed areas under influence of force exerted on the retaining mat by the housing.

### BRIEF DESCRIPTION OF THE DRAWINGS

FIG. 1 is a pictorial representation of a work machine according to an exemplary disclosed embodiment.

FIG. 2 is a diagrammatic illustration of an exhaust element retaining assembly according to an exemplary disclosed embodiment.

FIG. 3 is a diagrammatic illustration of a recessed area and the forces acting on a mat in the recessed area.

### DETAILED DESCRIPTION

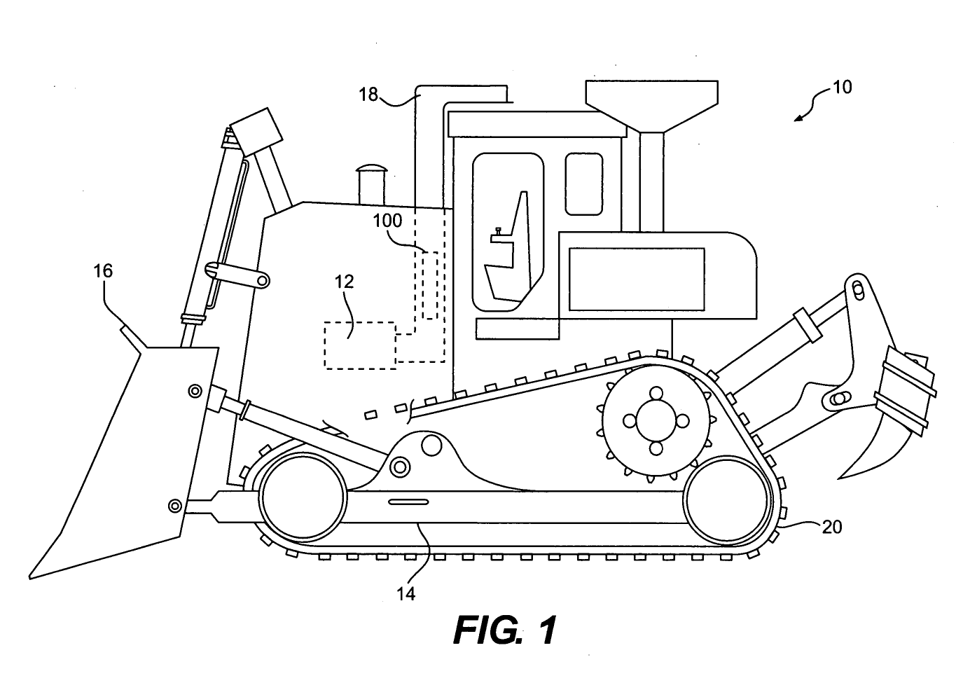

FIG. 1 provides a pictorial illustration of a work machine 10. Work machine 10 may include an engine 12. Work machine 10 may also include a frame 14 and a work implement 16. Engine 12 may be operably connected to an exhaust system 18. Engine 12 may include a diesel engine, a gasoline engine, or any other power producing device. Work machine 10 may also include a traction device 20. Exhaust system 18 may include an exhaust element retaining assembly 100.

While work machine 10 is shown as a track-type tractor, work machine 10 may include various types of machines. For example, work machine 10 may be a truck, wheeled tractor, dump truck, automobile, on-highway vehicle, off-highway vehicle, skid-steer, stationary generator, or any other device that includes an engine that generates an exhaust stream.

Exhaust system 18 may include components used to transfer exhaust produced by engine 12 or other exhaust producing devices to the atmosphere. For example, exhaust system 18 may include an exhaust manifold (not shown), a particulate filter or any other filtration device, a catalytic converter or any other catalytic device, a muffler, a tailpipe (not shown), and one or more exhaust conduits (e.g., exhaust pipes).

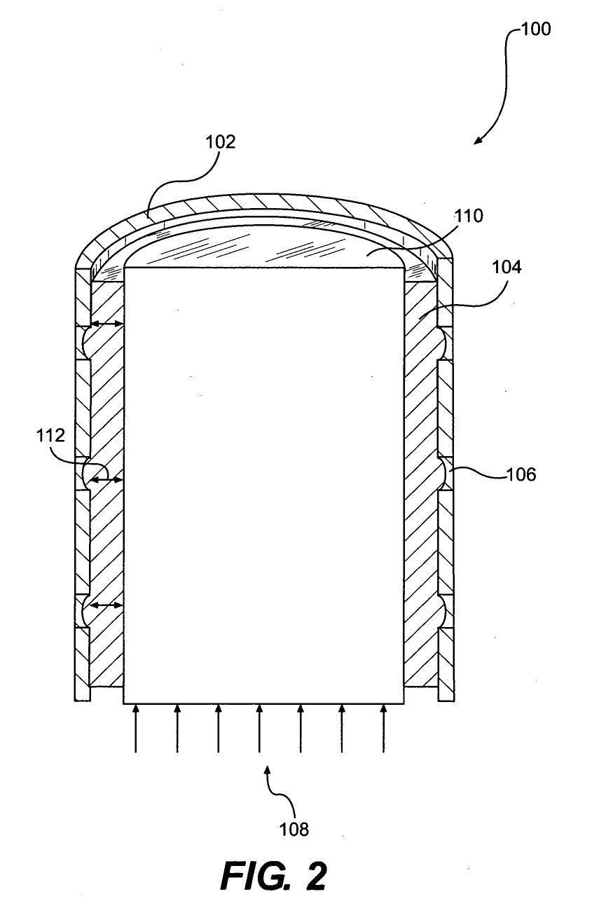

FIG. 2 illustrates exhaust element retaining assembly 100 according to an exemplary disclosed embodiment. Assembly 100 may include a housing 102. Assembly 100 may also include a mat 104, recessed areas 106 and exhaust element 110. Mat 104 may be arranged around exhaust element 110. Housing 102 may contain mat 104 and exhaust element 110. Recessed areas 106 may be formed on the inner surface of housing 102. Exhaust gas 108 may pass through exhaust element 110. Housing 102 may be configured to exert force 112 on mat 104.

Exhaust element 110 may be used to treat exhaust gas 108 as the gas flows through the element. In one embodiment, exhaust element 110 may include a catalytic converter. The catalytic converter may have a ceramic structure that may include compounds such as alumina, calcia and silicon nitride. This structure may be coated with one or more catalysts, for example, platinum, which may be used to reduce the amount of pollutants in exhaust gas 108. Exhaust element 110 may also include a particulate filter or any other filtration or catalytic device.

Mat 104 surrounds exhaust element 110 and provides protection to exhaust element 110. Specifically, mat 104 may shield exhaust element 110 from the operation of work machine 10. For example, mat 104 may be configured to absorb at least a portion of the vibrations or shocks generated from the operation of work machine 10. Moreover, mat 104 may be used to provide thermal insulation from exhaust element 110. For example, exhaust element 110 may be subject to the high temperatures of exhaust gas 108 passing through it, thus causing the element to be heated. Mat 104 may be made of material that provides thermal insulation to the rest of the assembly 100 from this heat in exhaust element 110. Mat 104 may also help exhaust element 110 cool quickly by absorbing at least a portion of the heat in the element created by the passing of exhaust gas 108. Mat 104 may be made of intumescent material, ceramic fiber, or any other such material.

Housing 102 surrounds mat 104 and may protect exhaust element 110. Housing 102 may include sheet steel or any other material known in the art as appropriate for this purpose.

Housing 102 may also be used to retain exhaust element 110. Housing 102 includes recessed areas 106 and may be sized such that housing 102 exerts force 112 on mat 104 during assembly. Force 112 causes at least a portion of mat 104 to extend completely or partially into recessed areas 106. This force is transferred to exhaust element 110 to hold it in place. This physical interlock between mat 104, recessed areas 106 and exhaust element 110 may help retain exhaust element 110 in the desired position. The engagement between mat 104 and housing 102 may prevent mat 104 from slipping in the space within housing 102. Thus, the recessed areas 106 may help housing 102 to retain exhaust element 110. It should be noted that force 112 may include radial force (as shown in FIG. 2), or axial force (not shown), or any other force that may be exerted by housing 102 on mat 104.

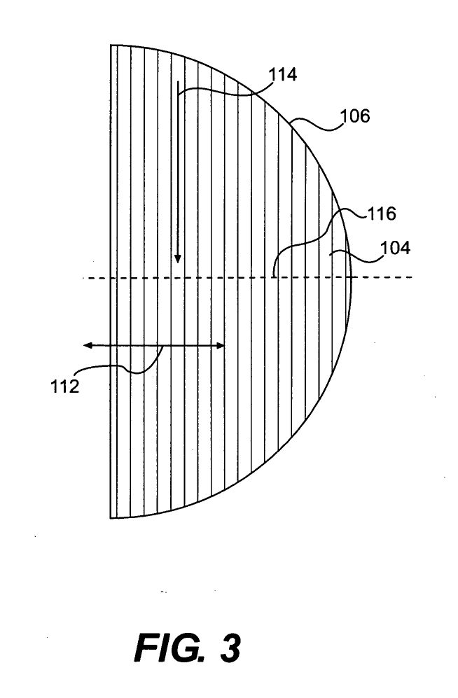

FIG. 3 shows how in one embodiment, recessed areas 106 may help retain mat 104 and thus, exhaust element 110. Assembly 100 may be assembled in a manner such that housing 102 may exert force 112 on mat 104.

This force 112 may cause at least a portion of mat 104 to at least partially extend into recessed areas 106. The extension of mat 104 into recessed areas 106 may help create a physical lock between mat 104 and housing 102. This lock may be created because of the downward force 114 exerted by recessed area 106, with respect to axis 116, on the portion of mat 104 that has extended into it. Force 114 may help retain exhaust element 110 by not permitting mat 104 to slip in the space within housing 102.

Recessed areas 106 may be of different shapes and sizes. For example, recessed areas 106 may be formed in the shape of annular rings on the inner surface of housing 102. Recessed areas 106 may also include round recesses, square recesses, oval recesses or any other such shape. The depth of the recessed areas may range from 0.5 mm to a depth equal to a thickness of the housing. Thus, the recessed areas could range from indentations having a certain depth to perforations that extend completely through housing 102.

The degree of retention of exhaust element 110 may depend on a number of factors. The depth of recessed areas 106 and the magnitude of the force 112 on mat 104 may affect the degree of retention of exhaust element 110 within retaining assembly 100. Specifically, the greater the depth of recessed area 106, the greater may be the degree of retention because there is a possibility that a larger portion of mat 104 may be able to extend into and thus interlock with housing 102. The degree of retention may also depend on the amount of force 112 exerted by housing 102 on mat 104. For example, a larger amount of force 112 exerted on mat 104 may cause a larger portion of mat 104 to extend into recessed areas 106 thereby increasing the amount of interlock between housing 102 and mat 104. This greater amount of interlock between mat 104 and housing 106 may help reduce the possibility of mat 104 slipping in the space within housing 102, thereby helping retain exhaust element 110 in its desired position.

### INDUSTRIAL APPLICABILITY

The presently disclosed exhaust element retaining assembly may be used in any exhaust treatment system that includes one or more exhaust elements positioned in an exhaust system. The use of recessed areas in the housing may help reduce the cost of the assembly 100. For example, sheet goods including pre-manufactured recessed areas suitable for use in the disclosed embodiments may be obtained from various suppliers. Because material including such recessed areas may be readily obtained without any custom/special requirements, the cost of components (e.g., housing 102) of the assembly may be reduced. In addition, the exhaust element need not be manufactured with custom interlocking features for engaging the housing. The lack of any special features on the element may help reduce its manufacturing costs.

Use of the disclosed assembly may help reduce costs to the manufacturer of the exhaust element and/or that of the work machine using the exhaust element. The lack of features on the body of the exhaust element for engaging/mating with the housing may help reduce the possibility of any breakage to the exhaust element during its use on a work machine. This lack of features may also help reduce the complexity of the manufacturing process of exhaust element 110. This simplicity in manufacturing may be achieved because there may be no need to build precisely located features to mate with corresponding features on the housing 102. The assembly may also help retain the exhaust element in any desired position by protecting it from exhaust gas loads, shocks, and/or vibrations inflicted upon it by operation of the work machine. These features may help reduce warranty costs to the manufacturer of the exhaust element and/or the work machine.

It will be apparent to those skilled in the art that various modifications and variations can be made in the disclosed assembly without departing from the scope of the disclosure. Additionally, other embodiments of the disclosed system will be apparent to those skilled in the art from consideration of the specification. It is intended that the specification and the examples be considered exemplary only, with a true scope of the disclosure being indicated by the following claims and their equivalents.

What is claimed is:

1. An exhaust element assembly comprising:
an exhaust element;
a retaining mat surrounding at least a portion of the exhaust element; and
a housing having a plurality of recessed areas on an inner surface of the housing, the housing being configured to engage the retaining mat such that at least a portion of the retaining mat extends at least partially into one or more of the plurality of recessed areas under influence of force exerted on the retaining mat by the housing.

2. The assembly of claim 1, wherein the at least a portion of the retaining mat extends into the one or more recessed areas under influence of at least one of radial force and axial force applied to the retaining mat by the housing.

3. The assembly of claim 1, wherein the plurality of recessed areas include at least one of annular rings, circular recesses, rectangular recesses, and oval recesses.

4. The assembly of claim 1, wherein each of the plurality of recessed areas has a depth ranging from about 0.5 mm to a depth equal to a thickness of the housing.

5. The assembly of claim 1, wherein the exhaust element includes a catalyst based device.

6. The assembly of claim 1, wherein the exhaust element includes a ceramic converter.

7. The assembly of claim 1, wherein the exhaust element includes a particulate trap.

8. The assembly of claim 1, wherein the housing is formed of sheet metal.

9. A method of retaining an exhaust element comprising:
surrounding at least a portion of the exhaust element with a retaining mat;
engaging the retaining mat with a housing, that includes a plurality of recessed area on an inner surface of the housing; and
exerting a force on the retaining mat by the housing so that at least a portion of the retaining mat extends at least partially into one or more of the plurality of recessed areas.

10. The method of claim 9, wherein the engaging further includes using the housing to exert at least one of radial force and axial force on the retaining mat.

11. The method of claim 9, wherein the plurality of recessed areas include at least one of annular rings, circular recesses, rectangular recesses, and oval recesses.

12. The method of claim 9, wherein each of the plurality of recessed areas has a depth ranging from about 0.5 mm to a depth equal to a thickness of the housing.

13. A machine comprising:
a frame;
an engine, which generates an exhaust stream, operably connected to the frame; and
an exhaust element assembly including:
an exhaust element;
a retaining mat surrounding at least a portion of the exhaust element; and
a housing having a plurality of recessed areas on an inner surface of the housing, the housing being configured to engage the retaining mat such that at least a portion of the retaining mat extends at least partially into one or more of the plurality of recessed areas under influence of force exerted on the retaining mat by the housing.

14. The machine of claim 13, wherein the at least a portion of the retaining mat extends into the one or more recessed areas under influence of at least one of radial force and axial force applied to the retaining mat by the housing.

15. The machine of claim 13, wherein the plurality of recessed areas include at least one of annular rings, circular recesses, rectangular recesses, and oval recesses.

16. The machine of claim 13, wherein each of the plurality of recessed areas has a depth ranging from about 0.5 mm to a depth equal to a thickness of the housing.

17. The machine of claim 13, wherein the exhaust element includes a catalyst based device.

18. The machine of claim 13, wherein the exhaust element includes a ceramic converter.

19. The machine of claim 13, wherein the exhaust element includes a particulate trap.

20. The work machine of claim 14, wherein the housing is formed of sheet steel.
